(19) United States
(12) Patent Application Publication
(10) Pub. No.: US 2026/0237022 A1
(43) Pub. Date: Aug. 13, 2026

(54) IMAGE PROCESSING SYSTEM, IMAGE PROCESSING METHOD, AND PROGRAM

(71) Applicant: Sony Interactive Entertainment Inc., Tokyo (JP)

(72) Inventor: Masato Mitsutake, Chiba (JP)

(73) Assignee: Sony Interactive Entertainment Inc., Tokyo (JP)

(21) Appl. No.: 19/633,771

(22) Filed: Mar. 30, 2026

Related U.S. Application Data
(63) Continuation of application No. PCT/JP2024/033479, filed on Sep. 19, 2024.

(30) Foreign Application Priority Data
Sep. 29, 2023 (JP) 2023-169759

(51) Int. Cl. G06T 3/4053; A63F 13/52; G06T 3/4007; G06T 3/4046

(52) U.S. Cl. CPC G06T 3/4053; A63F 13/52; G06T 3/4007; G06T 3/4046

(57) ABSTRACT

Systems and methods for image processing are disclosed. An example system includes a processor that acquires each of 1^{st} to n^{th} frames to be processed and acquires each of 1^{st} to n^{th} input frames; and acquires each of 1^{st} to n^{th} estimated frames by inputting each of the input frames to a machine learning model. The machine learning model includes a cumulative feature information output layer having the n^{th} input frame and the (n-1)^{th} auxiliary information as input, where the cumulative feature information output layer outputs an n^{th} cumulative feature information indicating the features of the 1^{st} to n^{th} input frames. The processor adjusts the number of pixels that the (n-1)^{th} cumulative feature information comprises so that the number of pixels is smaller than the number of estimated pixels, and acquires the (n-1)^{th} auxiliary information, based on (n-1)^{th} cumulative feature information having the adjusted number of pixels.

### CROSS-REFERENCES TO RELATED APPLICATIONS

This application is a Continuation application under 35 U.S.C. §111 of International Application No. PCT/JP2024/033479, filed September 19, 2024, which claims the priority of JP 2023-169759, filed September 29, 2023, the entire disclosure of which are incorporated herein by reference for all purposes.

### BACKGROUND

The present disclosure relates to an image processing system, image processing method, and program.

A technique of estimating a high-resolution image based on a low-resolution single image (super-resolution), using a machine learning model, has been conventionally known (see, for example, “Learning a Deep Convolutional Network for Image Super-Resolution,” by Chao Dong, Chen Change Loy, Kaiming He, Xiaoou Tang, in Proceedings of European Conference on Computer Vision (ECCV), 2014).

### SUMMARY

A system having a recursive configuration of inputting, in a machine learning model, a current frame (nth frame) and information indicating features of past frames (1st to (n-1)th frames) to enhance the image quality of the nth frame, in order to realize a super resolution in a moving image such as a game screen is of the interest. Using the information about past frames in addition to the current frame, estimation performance of the machine learning model can be expected to be improved.

However, if the information about the past frames having enhanced image quality is used as-is, in the system having the above-described recursive configuration, a processing load ends up increasing.

The object of the present disclosure is to provide an image processing system, image processing method, and program which improve the estimation performance and reduce the processing load.

The image processing system according to the present disclosure is an image processing system which includes at least one processor, where the at least one processor: acquires each of 1^{st} to n^{th} frames to be processed (n is a natural number equal to or greater than 2) having a number of initial pixels which is predetermined; acquires, based on each of the frames to be processed, each of the 1^{st} to n^{th} input frames by generating input frames corresponding to each of the frames to be processed and having a number of input pixels greater than the number of initial pixels; and acquires each of 1^{st} to n^{th} estimated frames having a number of estimated pixels by inputting each of the input frames to a machine learning model. The machine learning model includes a cumulative feature information output layer to which the n^{th} input frame and (n-1)^{th} auxiliary information based on (n-1)^{th} cumulative feature information indicating the features of the 1^{st} to (n-1)^{th} input frames, are inputted, where the cumulative feature information output layer outputs the n^{th} cumulative feature information indicating the features of the 1^{st} to n^{th} input frames. The at least one processor adjusts the number of pixels of the (n-1)^{th} cumulative feature information so that the number of pixels is smaller than the number of estimated pixels, and acquires the (n-1)^{th} auxiliary information, based on the (n-1)^{th} cumulative feature information having the adjusted number of pixels.

### BRIEF DESCRIPTION OF DRAWINGS

FIG. 1 is a drawing illustrating an example of a hardware configuration of an image processing system.

FIG. 2 is a drawing illustrating the overview of an image processing system.

FIG. 3 is a drawing schematically illustrating the process of an image processing system.

FIG. 4 is a function block diagram illustrating an example of functions realized by an image processing system.

FIG. 5 is a drawing explaining the processing in a rendering unit.

FIG. 6 is a drawing explaining the processing in an intermediate frame acquisition unit.

FIG. 7A is a drawing schematically illustrating an example of an intermediate frame.

FIG. 7B is a drawing schematically illustrating another example of an intermediate frame.

FIG. 8A is a flowchart illustrating an example of the flow of the processing executed by an image processing system.

FIG. 8B is a flowchart illustrating an example of the flow of the processing executed by an image processing system.

FIG. 9 is a drawing illustrating the overview of an image processing system 1 according to a variation of the present embodiment.

FIG. 10 is a function block diagram illustrating an example of functions realized by an image processing system according to a variation of the present embodiment.

### DETAILED DESCRIPTION

An example of an embodiment of the image processing system according to the present disclosure will be explained below with reference to the drawings.

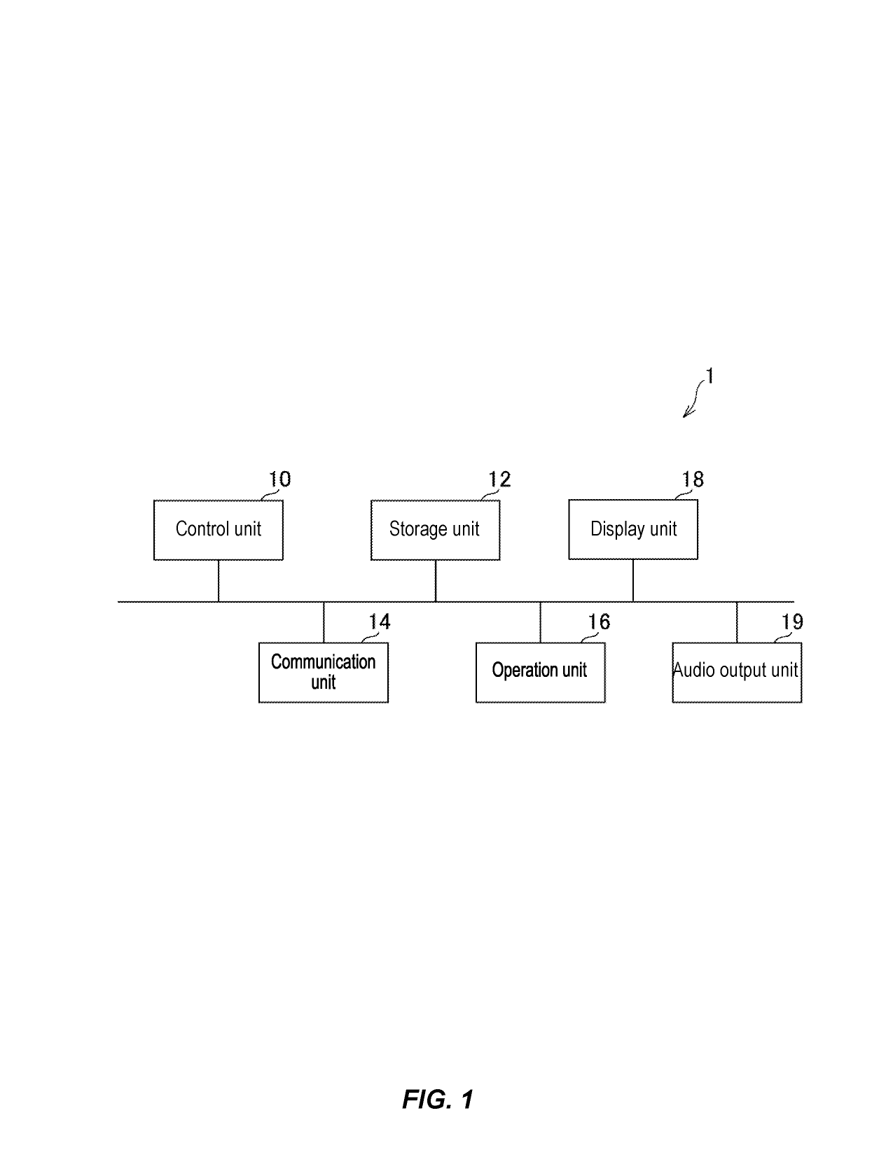

FIG. 1 is a drawing illustrating an example of a hardware configuration of an image processing system 1. The image processing system 1 is a computer of, for example, a game console (game machine), etc. As shown in FIG. 1, the image processing system 1 includes a control unit 10, a storage unit 12, a communication unit 14, an operation unit 16, a display unit 18 and an audio output unit 19.

The control unit 10 includes at least one processor. The control unit 10 is preferably, e.g. a program control device such as a CPU operating in accordance with a program to be installed in the image processing system 1. Moreover, the control unit 10 also includes a GPU (Graphics Processing Unit) depicting an image in a frame buffer based on graphics commands and data supplied from the CPU.

The storage unit 12 includes, e.g. a main storage device such as a ROM or a RAM etc., and an auxiliary storage device such as an HDD or an SSD, etc. Programs and the like executed by the control unit 10 are stored in the storage unit 12. The storage unit 12 stores, in addition to a program for realizing all functions of the image processing system 1 mentioned below, a game program (game software) for example. Moreover, a frame buffer area, of which an image is depicted by GPU, is ensured in the storage unit 12.

The communication unit 14 is a communication interface such as an Ethernet (registered trademark) module or a wireless LAN module, etc.

The operation unit 16 is a user interface such as a keyboard or a mouse, a controller for a game console, etc., which receives an operation input by a user, and outputs a signal indicating the content thereof to the control unit 10.

The display unit 18 is a display device such as a liquid crystal display, an organic EL display, etc., which displays various kinds of images in accordance with an instruction of the control unit 10.

The audio output unit 19 is, for example, a speaker, which outputs audio indicated by audio data generated by the image processing system 1.

Besides the devices mentioned above, the image processing system 1 may also include an optical disk drive which reads an optical disk such as a DVD-ROM or a Blu-ray (registered trademark) disk, etc. or a USB (Universal Serial Bus) port, etc.

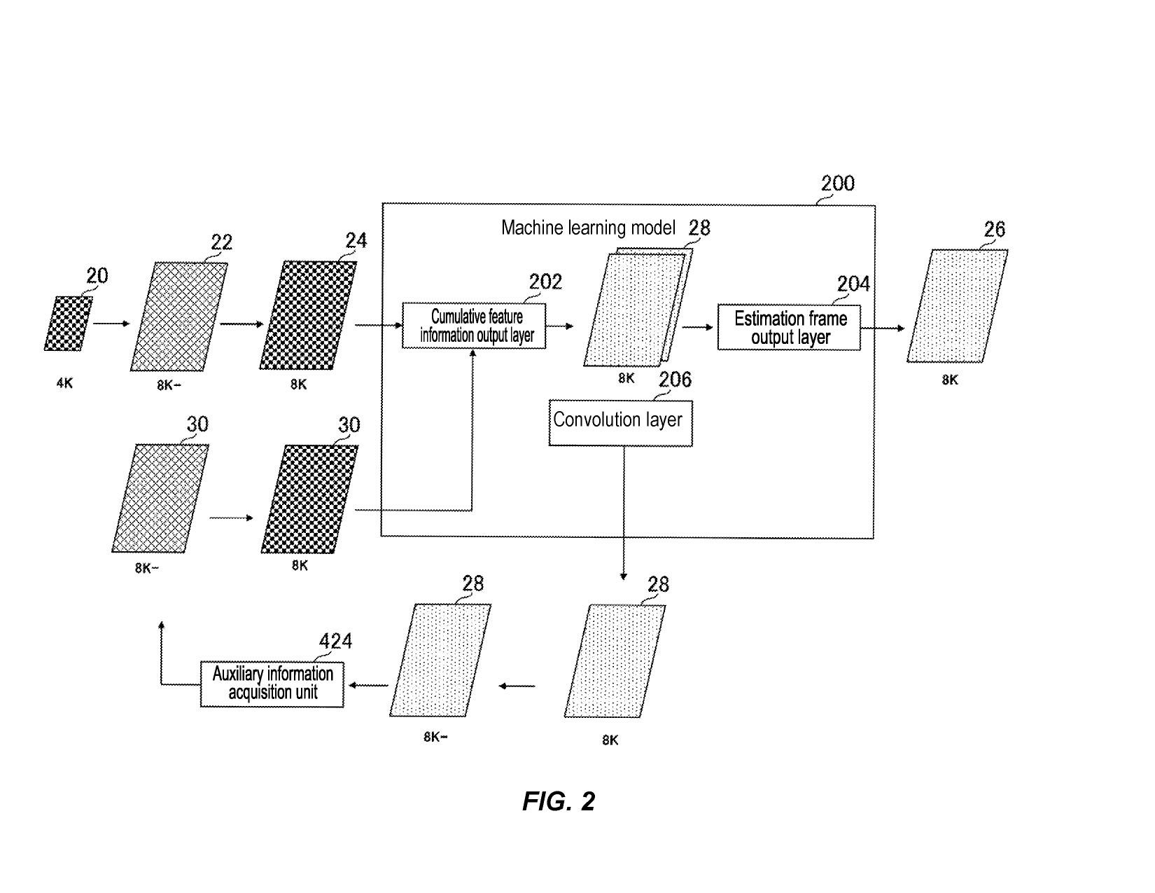

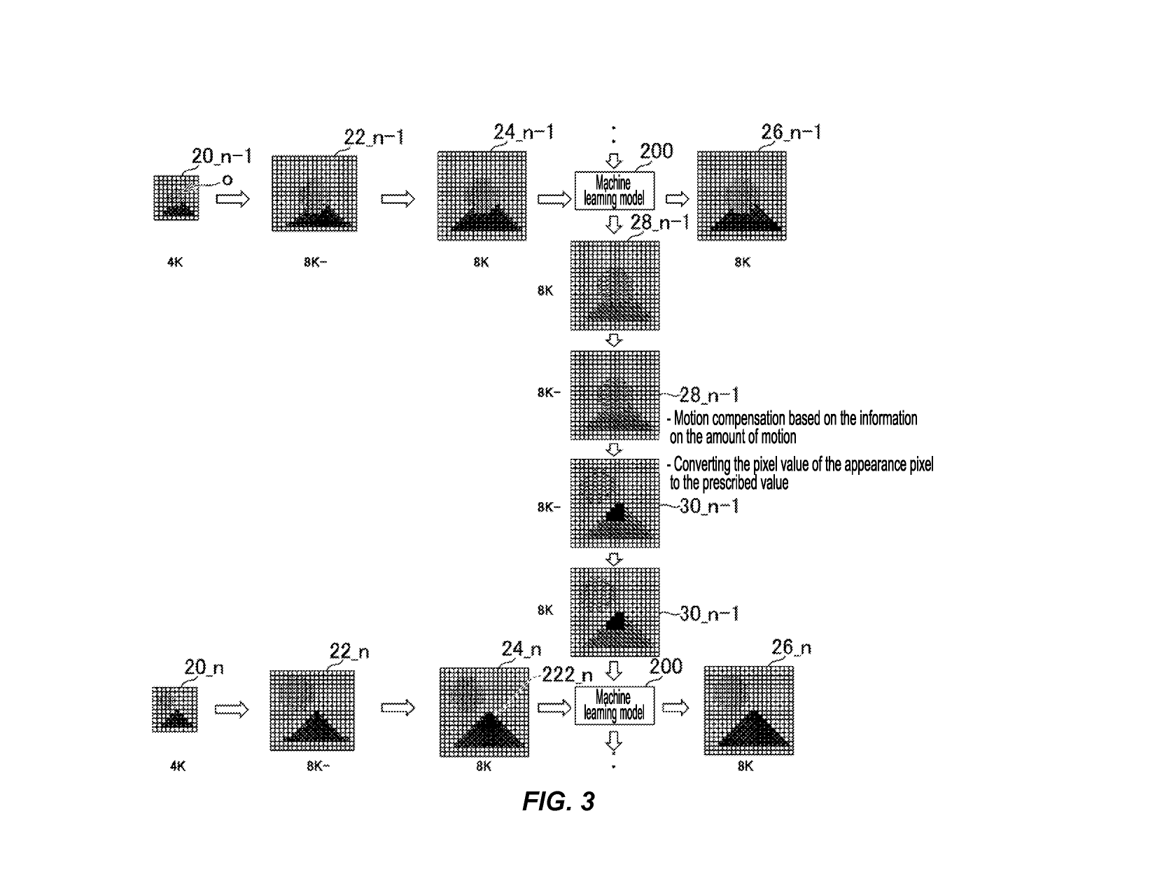

FIG. 2 is a drawing illustrating the overview of the image processing system 1. FIG. 3 is a drawing schematically illustrating the processing of the image processing system 1. The present embodiment exemplifies a case where the image processing system 1 is utilized to improve the image quality of a play moving image in a game. The play moving image is a moving image generated depending on a game program executed by the control unit 10 or an input by a user received by the operation unit 16, etc. and is configured from a plurality of still images (frames) which are time series data. The processing which takes place in the image processing system 1 is mainly as follows.

The image processing system 1 generates an image (frame 20 to be processed) where the game objects are depicted, by rendering three-dimensional data indicating one or more of these game objects as seen from a predetermined viewpoint. This frame 20 to be processed is an image having a number of pixels (number of initial pixels) which is predetermined and a predetermined image quality (initial image quality). The frame 20 to be processed is generated for every predetermined time. The number of initial pixels is, for example, 3840 x 2160 (4K).

Each generated frame to be processed is not displayed as-is on the display unit 18, but is once stored in the storage unit 12, and subsequent processing is applied to the generated frame to be processed. In the following explanation, processing of an n^{th} frame 20_n to be processed (2 ≤ n ≤ N, where n and N are natural numbers equal to or greater than 2) is mainly exemplified. Meanwhile, the same processing is also executed on the other frames to be processed (namely, n = 2, 3, ..., N).

The image processing system 1 acquires, based on the acquired frame 20_n to be processed, an intermediate frame 22_n having a number of intermediate pixels number greater than the number of initial pixels. The intermediate frame 22_n is generated by executing an enlargement and interpolation processing on the frame 20_n to be processed. The number of intermediate pixels (indicated as “8K-” in FIG. 2, etc.) is preferably greater than 3840 x 2160 (4K) and smaller than 7680 x 4320 (8K). For example, the number of intermediate pixels is preferably e.g. 7680 x 2160 or 3840 x 4320, which is a number of pixels obtained by thinning out a predetermined pixel row from 8K.

The image processing system 1 acquires an input frame 24_n having a number of input pixels greater than the number of intermediate pixels, based on the acquired intermediate frame 22_n. The input frame 24_n is generated by executing the enlargement and interpolation processing on the frame 20_n to be processed. The number of input pixels is, for example, 7680 x 4320 (8K).

Here, although the input frame 24_n has a number of pixels greater than the number of pixels of the frame 20_n to be processed, it should be noted that the image quality thereof has not necessarily been sufficiently improved. Namely, the image quality of a frame does not mean a mere large number of pixels (high degree of image quality). The image quality of the frame may be evaluated based on, for example, each of or a comprehensive consideration of a high SN ratio, high reproducibility of a space frequency, high time stability (few artefacts or flickering when a plurality of frames is continuously displayed), etc. when compared with a frame serving as a standard.

The image processing system 1 inputs the input frame 24_n to a machine learning model 200, and acquires an estimated frame 26_n. The estimated frame 26_n is an image having the same number of estimated pixels as the number of input pixels, and an image quality (estimated image quality) equal to or greater than the initial image quality. Therefore, if the number of input pixels is 7680 x 4320 (8K), the number of estimated pixels is also 7680 x 4320 (8K).

Here, in addition to the input frame 24_n, (n-1)^{th} auxiliary information 30_n-1 is inputted to the machine learning model 200 (see FIGS. 2 and 3). The auxiliary information 30_n-1 is information based on (n-1)^{th} cumulative feature information 28_n-1 indicating the features of the 1^{st} to the (n-1)^{th} input frames 24. Details of the cumulative feature information 28 and the auxiliary information 30 are described below.

The machine learning model 200 has a cumulative feature information output layer 202 having the input frame 24_n and the auxiliary information 30_n-1 inputted thereto, where the cumulative feature information output layer 202 outputs the n^{th} cumulative feature information 28_n indicating the features of the 1^{st} to n^{th} input frames 24 (see FIG. 2). The image processing system 1 acquires the n^{th} cumulative feature information 28_n.

The acquired n^{th} cumulative feature information 28_n is inputted to an estimated frame output layer 204, and the n^{th} estimated frame 26_n is outputted from the estimated frame output layer 204 (see FIG. 2). The acquired n^{th} cumulative feature information 28_n is also stored in the storage unit 12 and the estimation of the estimated frame 26_n+1 which corresponds to the next frame ((n+1)^{th} frame to be processed) 20_n+1 to be processed is applied to the acquired n^{th} cumulative feature information 28_n.

As mentioned above, the (n-1)^{th} cumulative feature information 28_n-1 is information indicating the features of the 1^{st} to (n-1)^{th} input frames 24 (and by extension, the 1^{st} to (n-1)^{th} frames 20 to be processed). If the cumulative feature information 28_n-1 of which the information of the past frames 20 to be processed was thereby accumulated, is used for the estimation of the n^{th} estimated frame 26_n, the information that can be used for the estimation increases and hence a high-image quality estimated frame 26_n can be obtained.

However, if, for example, there was movement and the like in the displayed game objects between the (n-1)^{th} frame 20_n-1 to be processed and the n^{th} frame 20_n to be processed, when the n^{th} input frame 24_n and the cumulative feature information 28_n-1 are inputted as-is to the machine learning model 200, a phenomenon could occur in which a residual image of a game object which was displayed in the (n-1)^{th} frame 20_n-1 to be processed ends up being displayed (so-called ghost phenomenon).

Thus, the image processing system 1 acquires the (n-1)^{th} auxiliary information 30_n-1 by applying various corrections mentioned below, based on information (motion vector, depth buffer, etc.) obtainable at the time of rendering, to the cumulative feature information 28_n-1 (see FIGS. 2 and 3). As mentioned above, the acquired (n-1)^{th} auxiliary information 30_n-1, together with the n^{th} input frame 24_n, are inputted to the machine learning model 200, and the estimation of the n^{th} estimated frame 26_n is applied to the (n-1)^{th} auxiliary information 30_n-1.

The image processing system 1 according to the present embodiment uses, in addition to the input frame 24 which corresponds to the present frame 20 to be processed, the auxiliary information 30 of which past information was accumulated, and estimates the estimated frame 26. Thereby, the information that can be used for the estimation increases and hence a high-image quality estimated frame 26_n can be obtained.

The cumulative feature information 28 to be outputted from the machine learning model 200 is information having the same number of pixels number as the estimated frame 26. Namely, the cumulative feature information 28 is information having the number of pixels of 8K. In the present embodiment, the number of pixels of the cumulative feature information 28 is adjusted to be set to the same number as the number of intermediate pixels of the intermediate frame 22. Then, based on the cumulative feature information 28 having the same number of pixels number as the number of intermediate pixels, the auxiliary information 30 having the same number of pixels as the number of intermediate pixels is obtained. Specifically, the number of pixels of the auxiliary information 30 is the number of pixels obtained by thinning out a predetermined pixel row from 8K and is preferably 7680 x 2160 or 3840 x 4320, etc.

Further, in the present embodiment, the pixel number of the auxiliary information 30 is increased to be set to the same number as the number of input pixels number of the input frame 24. Specifically, the number of pixels of the auxiliary information 30 is increased to 7680 x 4320 (8K). Then, the input frame 24 and the auxiliary information 30 having the same number of pixels as the number of input pixels are inputted to the machine learning model 200.

As such, the configuration of acquiring the auxiliary information 30 by using the cumulative feature information 28 having the number of pixels smaller than the number of estimated pixels of the estimated frame 26 is adopted, and thereby this configuration is capable of restricting the amount of use of a memory and the processing time at the time of acquiring the auxiliary information 30. Such reduction of the processing load is especially effective in a case where the image processing system 1 is applied to a game console having limited processing performance. Further, if the pixel number (information amount) of the auxiliary information 30 is reduced too much, the estimation accuracy in the machine learning model 200 may be insufficient. Meanwhile, in the present embodiment, the number of pixels of the auxiliary information 30 is made to be greater than the number of initial pixels of the frame 20 to be processed, so that the information relating to the past frames can be effectively used and the estimation accuracy can be maintained.

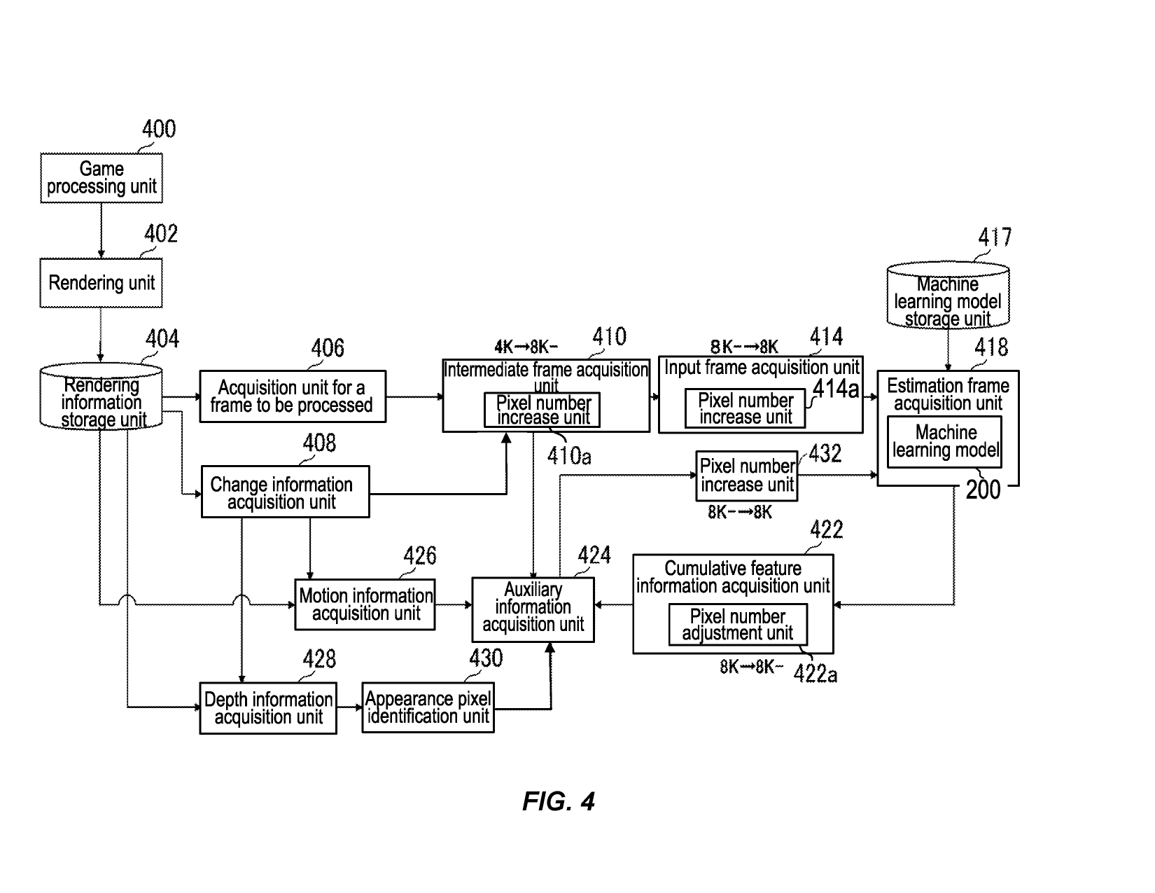

FIG. 4 is a function block diagram illustrating an example of functions realized by the image processing system 1. As shown in FIG. 4, in the image processing system 1, a game processing unit 400, a rendering unit 402, a rendering information storage unit 404, an acquisition unit for a frame to be processed 406, a change information acquisition unit 408, an intermediate frame acquisition unit 410, an input frame acquisition unit 414, a machine learning model storage unit 417, an estimated frame acquisition unit 418, a cumulative feature information acquisition unit 422, an auxiliary information acquisition unit 424, a motion information acquisition unit 426, a depth information acquisition unit 428, an appearance pixel identification unit 430, and a number of pixels increase unit 432 are realized.

The game processing unit 400, the rendering unit 402, the acquisition unit for a frame to be processed 406, the change information acquisition unit 408, the intermediate frame acquisition unit 410, the input frame acquisition unit 414, the estimated frame acquisition unit 418, the cumulative feature information acquisition unit 422, the auxiliary information acquisition unit 424, the motion information acquisition unit 426, the depth information acquisition unit 428, the appearance pixel identification unit 430 and the number of pixels increase unit 432 are realized mainly by the control unit 10. The rendering information storage unit 404 and the machine learning model storage unit 417 are realized mainly by the storage unit 12. The game processing unit 400, the rendering unit 402 and the rendering information storage unit 404 have functions provided by game software.

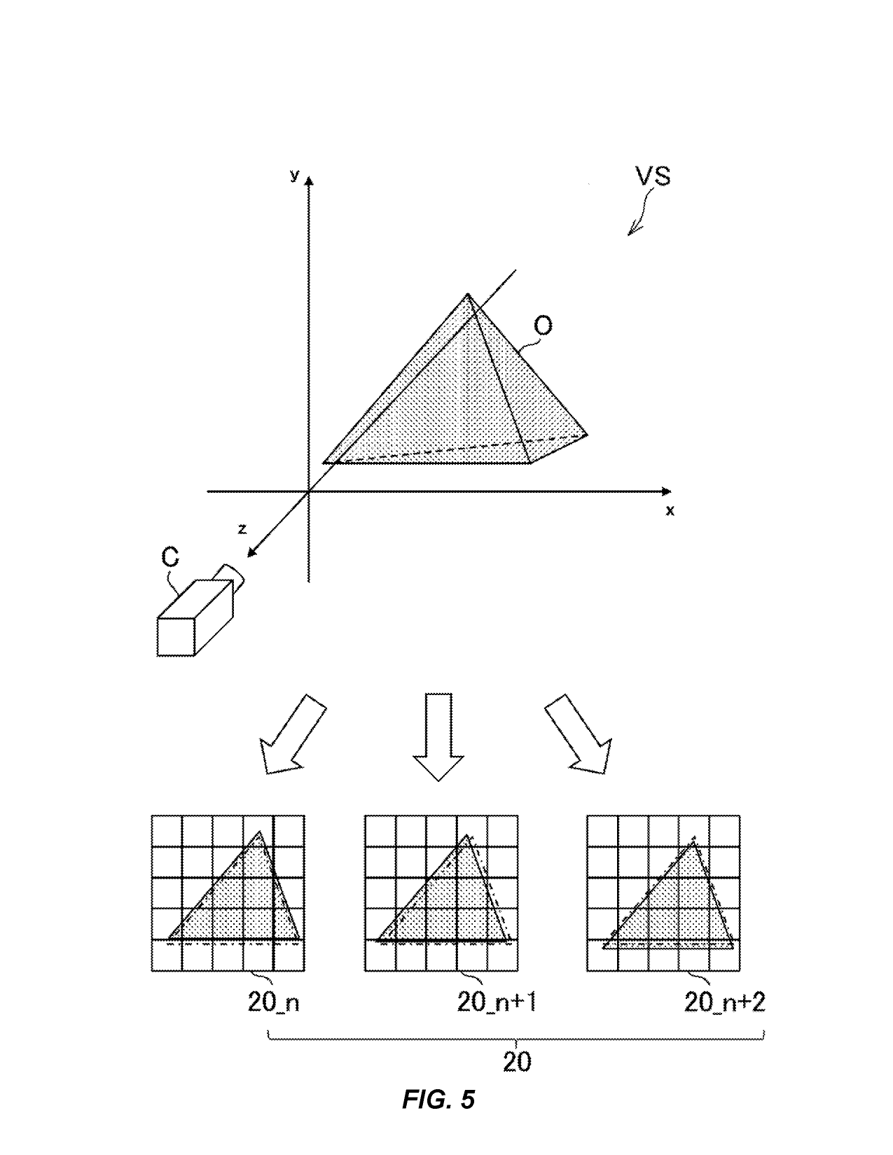

The game processing unit 400 executes various processes relating to a game. The game processing unit 400 executes, for example, the following processes: arranging a game object O in a virtual three-dimensional space VS, operating or moving the game object O, and changing a viewpoint C for viewing the virtual three-dimensional space VS, etc., depending on the game program executed by the control unit 10 or the input by a user received by the operation unit 16 (see FIG. 5). The game object O is configured by a primitive such as a polygon indicated by three-dimensional data. The three-dimensional data includes geometrical information indicating the position of a vertex, etc., phase information indicating how the vertices are joined, and attribute information such as colour, etc.

FIG. 5 is a drawing explaining the processing in the rendering unit 402. The rendering unit 402 generates the 1^{st} to N^{th} frames 20 to be processed (N is a natural number equal to or greater than 2) by executing the rendering (depiction processing) of the three-dimensional data indicating one or more of the game objects O as seen from the predetermined viewpoint C. The rendering unit 402 executes the rendering based on the various processing results executed by the game processing unit 400. Specifically, the rendering unit 402 executes vertex processing (vertex shading) and pixel processing (pixel shading), based on the three-dimensional data indicating the game object O arranged in the virtual three-dimensional space VS. The vertex processing includes coordinate conversion processing (perspective projection) from a view coordinate system to a screen coordinate system, and a numerical value relating to a change of the viewpoint C is added to a perspective projection matrix (camera matrix) which is used for the coordinate conversion processing, as mentioned below. The rendering unit 402 may also execute the rendering based on light source information or depth information (depth buffer), texture information, and normal line information, etc.

Here, the rendering unit 402 generates each frame 20 to be processed by executing the rendering so that the viewpoint C changes for every frame 20 to be processed. Here, even if the game processing unit 400 had fixed the viewpoint C to a predetermined position, the rendering unit 402 changes the viewpoint C for every frame 20 to be processed. As a result, as shown in FIG. 5, the position of the displayed game object O changes in each of the frames to be processed 20_n, 20_n+1, and 20_n+2. In other words, the rendering unit 402 applies jitter at the time of generating each frame 20 to be processed. Specifically, the rendering unit 402 changes the viewpoint C for every frame 20 to be processed by adding, to the perspective projection matrix, a numerical value corresponding to a size of less than one pixel, which differs for every frame 20 to be processed. The rendering unit 402 changes the viewpoint C for every frame 20 to be processed, in accordance with a predetermined rule. The Halton sequence, for example, can be used as such a rule.

The rendering information storage unit 404 stores information required in the rendering process by the rendering unit 402, and information obtainable as a result of the rendering process. For example, the rendering information storage unit 404 stores the frame 20 to be processed. Moreover, the rendering information storage unit 404 stores the change information, motion information and depth information. Details of the change information, the motion information and the depth information are described below. In addition, the rendering information storage unit 404 may store parameters used for coordinate conversion, light source information, texture information, and normal line information, etc.

The acquisition unit for a frame to be processed 406 acquires each of 1^{st} to N^{th} frames 20 to be processed. Specifically, the acquisition unit for a frame to be processed 406 acquires each of the 1^{st} to N^{th} frames 20 to be processed stored in the rendering information storage unit 404.

The change information acquisition unit 408 acquires the change information. The change information acquisition unit 408 acquires the change information stored in the rendering information storage unit 404. Specifically, the change information is information indicating the amount of change of the viewpoint C before and after the change. The information indicating the amount of change can also be a change vector indicating the direction and the distance of change. For example, since the information indicating the amount of change of the viewpoint C is included in the aforementioned Halton sequence, such information may be used as the change information.

The intermediate frame acquisition unit 410 includes a pixel number increase unit 410a for enlarging the frame 20 to be processed. The intermediate frame acquisition unit 410 increases, by the pixel number increase unit 410a, the number of pixels of the 1^{st} to N^{th} frames 20 to be processed and, at the same time, the intermediate frame acquisition unit 410 acquires each of the 1^{st} to N^{th} intermediate frames 22. Specifically, the intermediate frame acquisition unit 410 obtains, by interpolation, a pixel value of a position corresponding to each pixel before the change, in the frame 20 to be processed, based on the change information and each pixel of each frame 20 to be processed, thereby generating each intermediate frame 22.

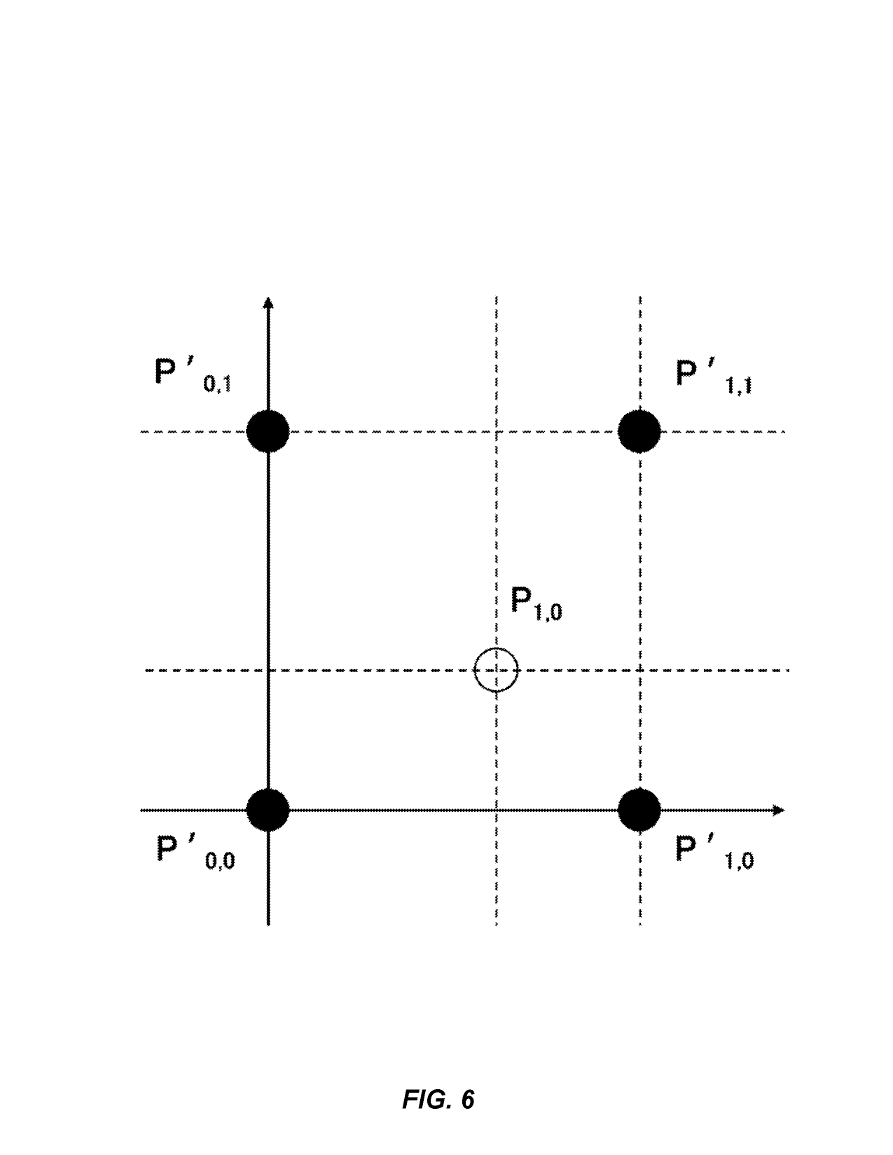

FIG. 6 is a drawing explaining the processing in the intermediate frame acquisition unit 410. FIG. 6 exemplifies a case of obtaining the n^{th} intermediate frame 22_n. For example, as shown in FIG. 6, if a pixel center of a pixel in the intermediate frame 22_n intended to be acquired is P1,0, the intermediate frame acquisition unit 410 obtains a pixel value of P1,0 by bilinear interpolation, based on the coordinates and the pixel values of the pixel centers P’0,0, P’1,0, P’0,1, P’1,1 of the four respective pixels closest to P1,0 in the frame 20_n to be processed. Here, P’1,0 is at a position shifted from P1,0 by the amount of change indicated by the change information. A pixel value of a newly generated pixel is also similarly obtained by the enlargement processing. In addition to the bilinear interpolation, various publicly known methods such as bicubic interpolation and Lanczos interpolation, etc. can be used as the method of interpolation.

When the rendering is executed so that the viewpoint C changes for every frame 20 to be processed, while the amount of time series information increases, each of the thus obtained frames 20 to be processed (hereinunder “changed frame to be processed”) is utilized for the estimation, so that a higher image quality estimated frame 26 can be obtained.

On the other hand, if the changed frame to be processed (or an enlarged image thereof) is inputted as-is to the machine learning model 200, the estimation accuracy may end up being reduced due to the influence of the aforementioned change of the viewpoint C.

Thus, as described above, in the image processing system 1, the pixel value of the position corresponding to each pixel before the change is obtained by the interpolation in the frame 20 to be processed, based on the change information and each pixel of each frame 20 to be processed, and each intermediate frame 22 is generated. Then, the input frame 24 generated by further increasing the number of pixels of each intermediate frame 22 is inputted to the machine learning model 200. Thereby, the influence of the change of the viewpoint C is corrected, and hence the reduction of the estimation accuracy can be suppressed.

The input frame acquisition unit 414 includes a pixel number increase unit 414a which enlarges the intermediate frame 22. The input frame acquisition unit 414 increases the number of pixels of the 1^{st} to N^{th} intermediate frames 22 by the pixel number increase unit 414a and, at the same time, acquires each of the 1^{st} to N^{th} input frames 24. The number of pixels is preferably increased by a method such as the bilinear interpolation, etc.

The machine learning model 200 is a model which estimates the n^{th} estimated frame 26_n, based on the n^{th} input frame 24_n. Specifically, the machine learning model 200 is a model which estimates the n^{th} estimated frame 26_n, based on the n^{th} input frame 24_n and the (n-1)^{th} auxiliary information 30_n-1. Specifically, the machine learning model 200 is a convolutional neural network (CNN). Publicly known models such as multilayer structure ResNet having a residual connection mechanism and the so-called encoder-decoder type U-Net, etc. can be used as the machine learning model 200. The model described in Non Patent Literature 1 may also be used as the machine learning model 200.

The machine learning model 200 is a model which was trained by the plurality of training data which respectively includes a learning input frame having a number of input pixels, and a learning estimated frame having a number of estimated pixels. Various publicly known methods such as backpropagation, etc. can be used for the learning by the machine learning model 200.

Specifically, the machine learning model 200 includes the cumulative feature information output layer 202, the estimated frame output layer 204 and a convolution layer 206 (see FIG. 2).

The cumulative feature information output layer 202 has the n^{th} input frame 24_n and the (n-1)^{th} auxiliary information 30_n-1 based on the (n-1)^{th} cumulative feature information 28_n-1 indicating the features of the 1^{st} to (n-1)^{th} input frames 24 inputted thereto, and the cumulative feature information output layer 202 outputs the n^{th} cumulative feature information 28_n indicating the features of the 1^{st} to n^{th} input frames 24_n. The cumulative feature information output layer 202 may be configured from, for example, one or more convolution layers.

The cumulative feature information 28_n-1 is image information having the same number of pixels as the number of input pixels (bitmap format information). The cumulative feature information 28_n-1 may also be referred to as a feature map indicating the features of the 1^{st} to (n-1)^{th} input frames 24.

The cumulative feature information output layer 202 has the 1^{st} input frame 24_1 and the given auxiliary information inputted thereto, and outputs the 1^{st} cumulative feature information 28_1. When n = 1, because the cumulative feature information 28 and auxiliary information 30 do not exist prior thereto, the given auxiliary information prepared beforehand, together with the 1^{st} input frame 24_1, are inputted to the cumulative feature information output layer 202.

The estimated frame output layer 204 has the n^{th} cumulative feature information 28_n inputted thereto and outputs the n^{th} estimated frame 26_n. The estimated frame output layer 204 may be configured from, for example, one or more convolution layers like the cumulative feature information output layer 202. Alternatively, the estimated frame output layer 204 may also be configured from one or more transposed convolution layers (reverse convolution layers).

The convolution layer 206 is a layer which maintains the number of pixels of the cumulative feature information 28, whilst reducing the channel number thereof. The cumulative feature information 28 outputted from the convolution layer 206 has the process with the auxiliary information acquisition unit 424 applied thereto. Since the dimensions of the cumulative feature information 28 are reduced according to the convolution layer 206, the calculation costs can be reduced. The convolution layer 206 is, for example, a convolution layer with a kernel size of 1x 1, but is not limited to this.

The machine learning model storage unit 417 stores the machine learning model 200. Specifically, the machine learning model storage unit 417 stores the parameters of the machine learning model 200 (the number of convolution layers, the number of notes used in each convolution layer, and the weight of each note, etc.).

The estimated frame acquisition unit 418 inputs each input frame 24 to the machine learning model 200, and acquires each of the 1^{st} to N^{th} estimated frames 26 having the number of estimated pixels. In the present embodiment, the estimated frame 26 has the same number of estimated pixels as the number of input pixels. More specifically, the estimated frame acquisition unit 418 inputs the n^{th} input frame 24_n and the (n-1)^{th} auxiliary information 30_n-1 to the machine learning model 200, and acquires the n^{th} estimated frame 26_n.

The motion information acquisition unit 426 acquires the (n-1)^{th} motion information which is information indicating the amount and the direction of the motion from the (n-1)^{th} frame 20_n-1 to be processed to the n^{th} frame 20_n to be processed. Specifically, the (n-1)^{th} motion information is image information which has pixels with the same number as the number of intermediate pixels, and which indicates the amount and the direction of the motion of each pixel between the (n-1)^{th} frame 20_n-1 to be processed and the n^{th} frame 20_n to be processed (bitmap format information). The motion information is also called a motion vector. Specifically, the motion information acquisition unit 426 acquires original motion information having the same number of pixels as the number of input pixels, and acquires the motion information having the pixels with the same number as the number of intermediate pixels by executing the enlargement and the interpolation processing on the original motion information.

The depth information acquisition unit 428 acquires the (n-1)^{th} depth information indicating each pixel depth of the (n-1)^{th} frame 20_n-1 to be processed, and the n^{th} depth information indicating each pixel depth of the n^{th} frame 20_n to be processed. Specifically, the depth information is image information having the pixels with the same number as the number of intermediate pixels (bitmap format information). The depth information is also called depth buffer or Z buffer. Specifically, the depth information acquisition unit 428 acquires original depth information having the same number of pixels as the number of initial pixels, and acquires the depth information having the pixels with the same number as the number of intermediate pixels by executing the enlargement and the interpolation processing on the original depth information.

The appearance pixel identification unit 430 identifies, based on the (n-1)^{th} depth information and the n^{th} depth information, an n^{th} appearance pixel 222_n from the pixels of the n^{th} input frame 24_n, where the n^{th} appearance pixel 222_n is a fully or partially displayed pixel of the game object O which is not displayed in the (n-1)^{th} intermediate frame 22_n-1 (see FIG. 3). Specifically, the appearance pixel identification unit 430 identifies the n^{th} appearance pixel 222_n, based on the difference between the (n-1)^{th} depth information and the n^{th} depth information. The appearance pixel identification unit 430 may also identify the n^{th} appearance pixel 222_n, based on the (n-1)^{th} perspective projection matrix relating to the (n-1)^{th} intermediate frame 22_n-1 and the n^{th} perspective projection matrix relating to the n^{th} intermediate frame 22_n. Moreover, the appearance pixel identification unit 430 may also identify the n^{th} appearance pixel 222_n by utilizing the (n-1)^{th} motion information. More specifically, the appearance pixel identification unit 430 identifies the n^{th} appearance pixel, and generates an n^{th} appearance pixel information, which is image information indicating the position of the n^{th} appearance pixel 222_n.

The cumulative feature information acquisition unit 422 includes a pixel number adjustment unit 422a. The pixel number adjustment unit 422a adjusts the number of pixels of the cumulative feature information 28, thereby setting it to the same number of pixels as the number of intermediate pixels. The cumulative feature information acquisition unit 422 acquires the cumulative feature information 28 having the adjusted number of pixels.

The auxiliary information acquisition unit 424 acquires the (n-1)^{th} auxiliary information 30_n-1 so that motion compensation is applied to the (n-1)^{th} cumulative feature information 28_n-1, based on the (n-1)^{th} motion information. The motion compensation is processing to move the pixel at the position x of the (n-1)^{th} cumulative feature information 28_n to a position x’, for example, in case a pixel at a position x at the (n-1)^{th} intermediate frame 22_n-1 had moved to the position x’ at the n^{th} intermediate frame 22_n (see FIG. 5). Namely, the auxiliary information acquisition unit 424 acquires, based on the (n-1)^{th} motion information, the (n-1)^{th} auxiliary information 30_n-1 so that each pixel value of the one or more pixels of the (n-1)^{th} cumulative feature information 28_n-1 is set to the pixel at a moved position in accordance with the amount and the direction of the motion of the pixel.

In case there was movement in the game object O between the n^{th} frame 20_n to be processed and the (n-1)^{th} frame 20_n-1 to be processed, at the time of acquiring the n^{th} estimated frame 26_n, if the n^{th} input frame 24_n and the (n-1)^{th} cumulative feature information 28_n-1 are inputted as-is to the machine learning model 200, a ghost phenomenon could occur in the n^{th} estimated frame 26_n to be outputted, in which a residual image of the game object O, which was displayed in the n^{th} input frame 24_n, ends up being displayed.

Thus, as described above, the image processing system 1 is configured to acquire the (n-1)^{th} auxiliary information 30_n-1 so that the motion compensation is applied to the (n-1)^{th} cumulative feature information 28_n-1, based on the (n-1)^{th} motion information, and, at the time of acquiring the n^{th} estimated frame 26_n, the (n-1)^{th} auxiliary information 30_n-1 is inputted to the machine learning model 200. Thereby, the aforementioned ghost phenomenon can be suppressed.

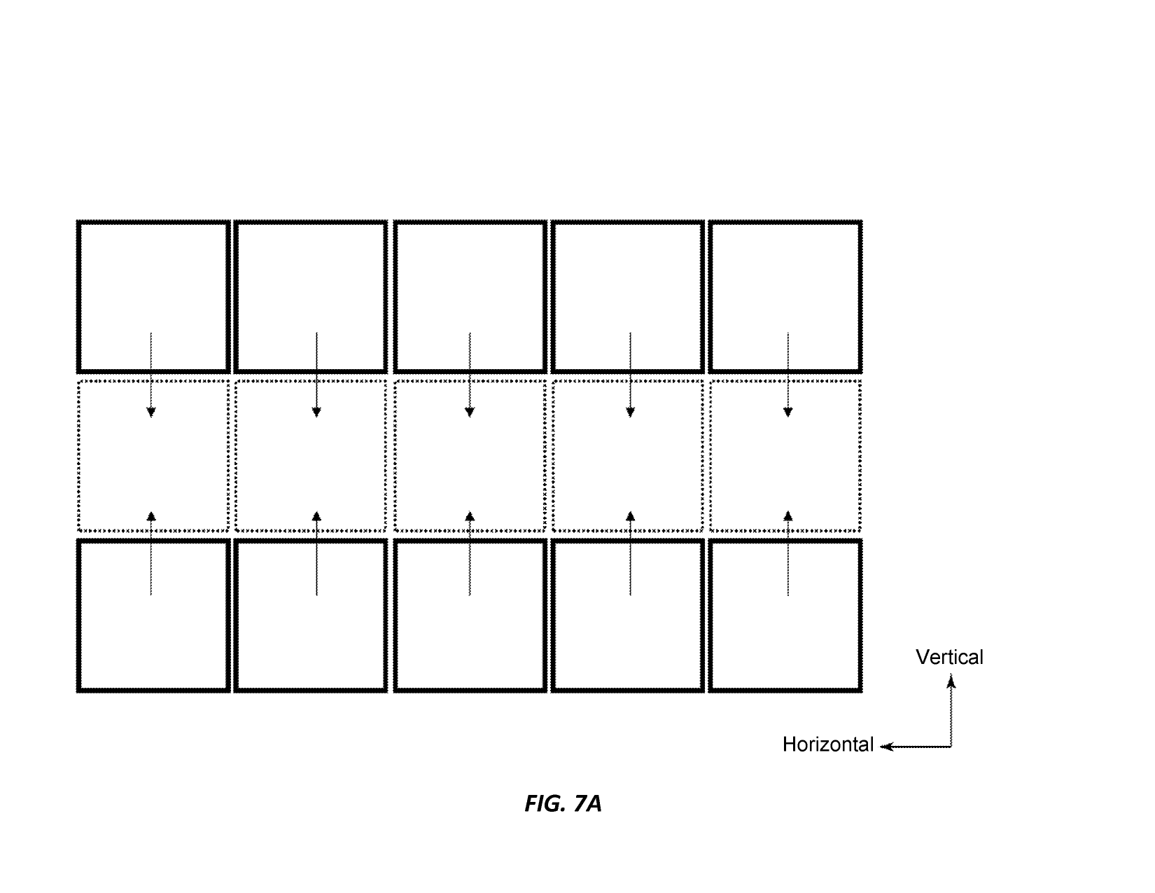

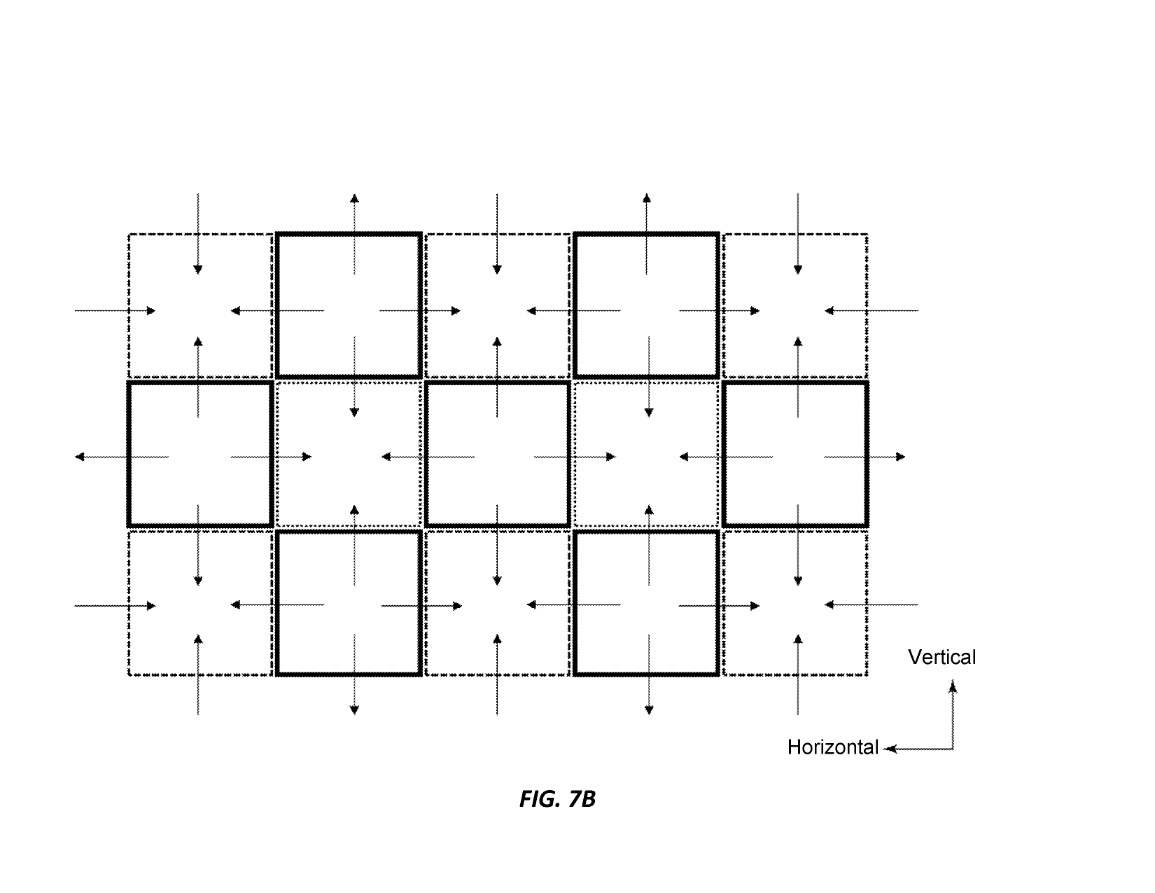

Now, by referring to FIG. 7A and FIG. 7B, the intermediate frame according to the present embodiment will be explained. As described above, the intermediate frame 22 is preferably a frame formed by thinning out vertical or horizontal pixel rows from a plurality of pixel rows arranged in a lattice shape, where the pixels constitute 8K, and, at the same time, formed by interpolating information relating to pixel rows adjacent to the thinned-out pixel rows.

FIG. 7A schematically shows an example where the horizontal pixel rows are thinned out and the information relating to the pixels adjacent to the thinned-out pixels is interpolated. In FIG. 7A, the thinned-out pixels are shown by dotted lines and the direction of the interpolated information is shown by arrows. The same also applies to FIG. 7B.

Otherwise, for example, the intermediate frame 22 is preferably a frame where the pixel is thinned out for every pixel from the plurality of pixels arranged in the lattice shape, where the pixels constitute 8K, and, at the same time, the information relating to each pixel adjacent to the thinned-out pixels is interpolated. FIG. 7B schematically shows an example where the information relating to the pixels adjacent to the pixels thinned out for every pixel is interpolated. In the example shown in FIG. 7B, the number of pixels adjacent to the thinned-out pixels is greater than that in the example shown in FIG. 7A, and thus the interpolation for the information can be performed with high accuracy.

The number of intermediate pixels is not limited to 7680 x 2160 or 3840 x 4320 and is preferably at least greater than the number of initial pixels and smaller than the number of estimated pixels.

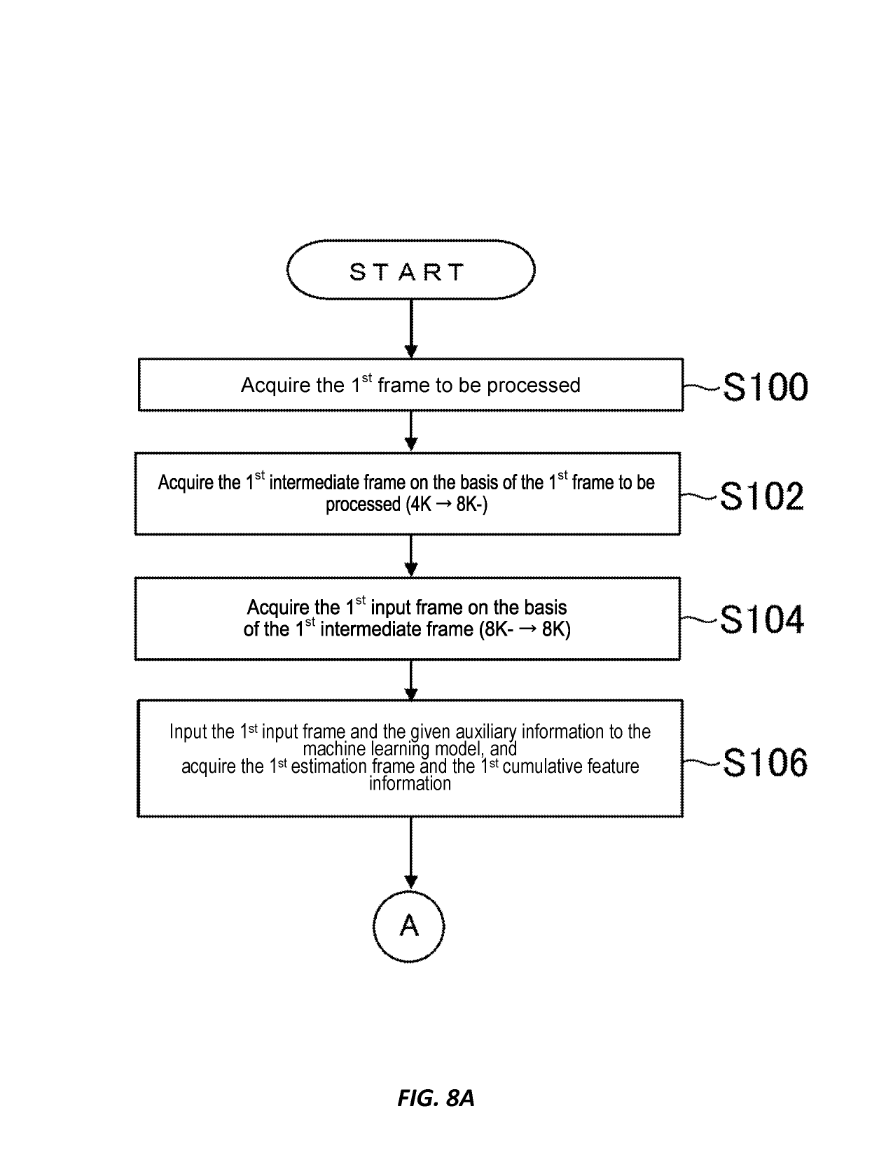

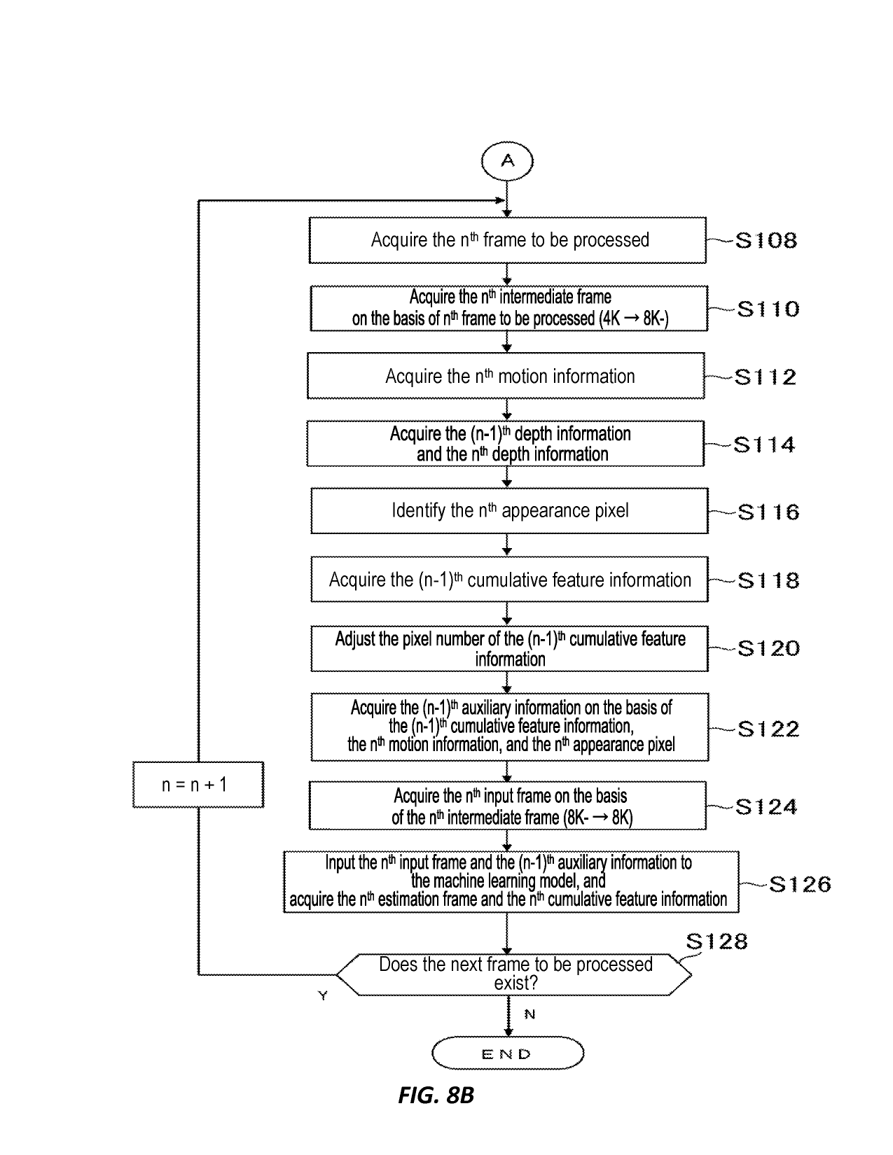

FIGS. 8A and 8B are flowcharts illustrating examples of the flows of the processing executed by the image processing system 1. The processing shown in FIGS. 8A and 7B is executed by the control unit 10 operating in accordance with the program stored in the storage unit 12.

FIG. 8A shows the processing in n = 1. First, the control unit 10 acquires the 1^{st} frame 20_1 to be processed (S100). The control unit 10 acquires, based on the 1^{st} frame 20_1 to be processed, the 1^{st} intermediate frame 22_1 (S102). At this time, the number of pixels of the frame is increased.

Further, the control unit 10 acquires, based on the 1^{st} intermediate frame 22_1, the 1^{st} input frame 24_1 (S104). At this time, the number of pixels of the frame is increased.

Moreover, the control unit 10 inputs the 1^{st} input frame 24_1 and the given auxiliary information to the machine learning model 200, and acquires the 1^{st} estimated frame 26_1 and the 1^{st} cumulative feature information 28_1 (S106).

FIG. 8B shows the processing in n = 2 and thereafter. The control unit 10 acquires the n^{th} frame 20_n to be processed (S108). The control unit 10 acquires, based on the n^{th} frame 20_n to be processed, the n^{th} intermediate frame 22_n (S110). At this time, the number of pixels of the frame is increased.

Next, the control unit 10 acquires the n^{th} motion information (S112). Moreover, the control unit 10 acquires the (n-1)^{th} depth information and the n^{th} depth information (S114), and identifies, based on the (n-1)^{th} depth information and the n^{th} depth information, the n^{th} appearance pixel 222_n (S116).

The control unit 10 acquires the (n-1)^{th} cumulative feature information acquired in the past (S118) and adjusts the number of pixels thereof (S120). Then, the control unit 10 acquires the (n-1)^{th} auxiliary information 30_n-1, based on the (n-1)^{th} cumulative feature information 28_n-1, the n^{th} motion information, and the n^{th} appearance pixel 222_n (S122).

Further, the control unit 10 acquires the n^{th} input frame 24_n, based on the n^{th} intermediate frame 22_n (S124). At this time, the number of pixels of the frame is increased.

Then, the control unit 10 inputs the n^{th} input frame 24_n and the (n-1)^{th} auxiliary information 30_n-1 to the machine learning model 200, and acquires the n^{th} estimated frame 26_n and the n^{th} cumulative feature information 28_n (S126).

Then, the control unit 10 determines whether or not the next frame exists (S128), and, if it was determined that the next frame does exist (S128; Y), the frame is incremented to n=n+1, and the processes of S108 to S126 are repeated. If the control unit 10 has determined that the next frame does not exist (S128; N), this processing terminates.

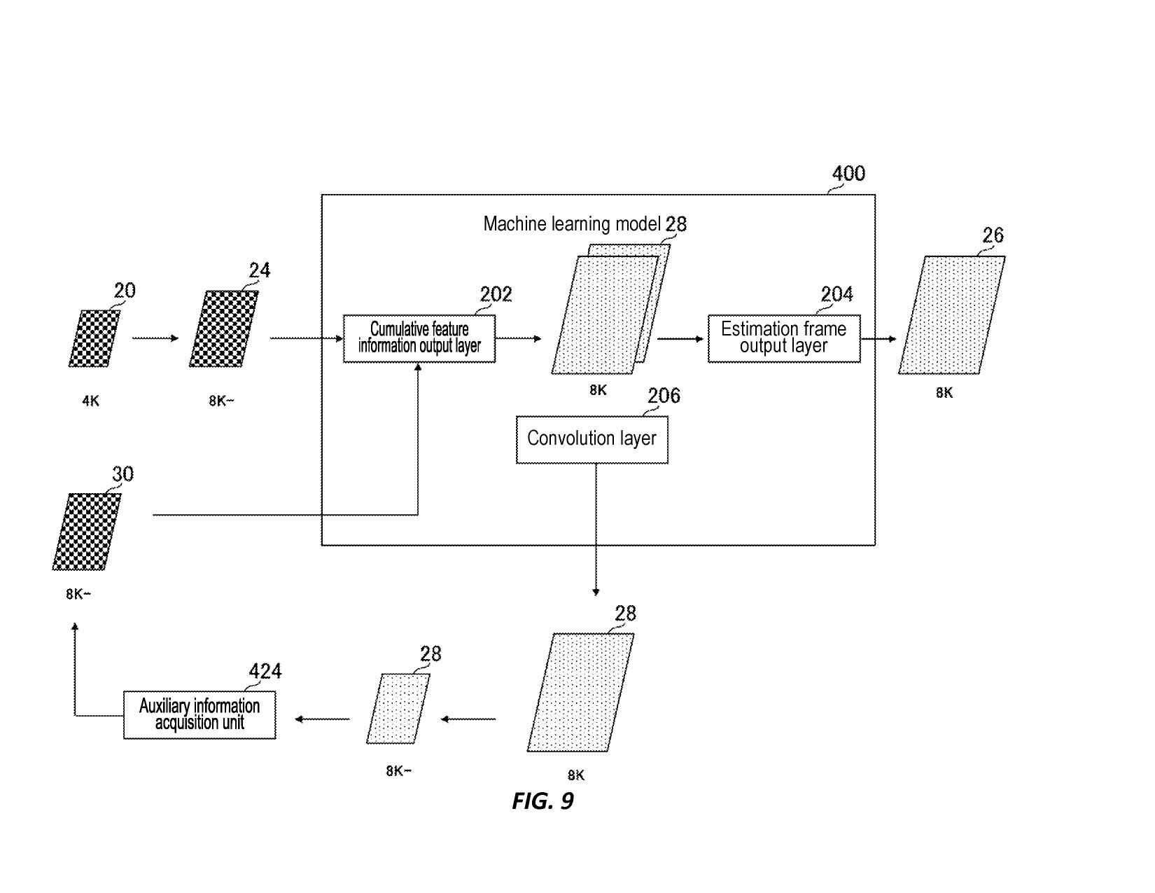

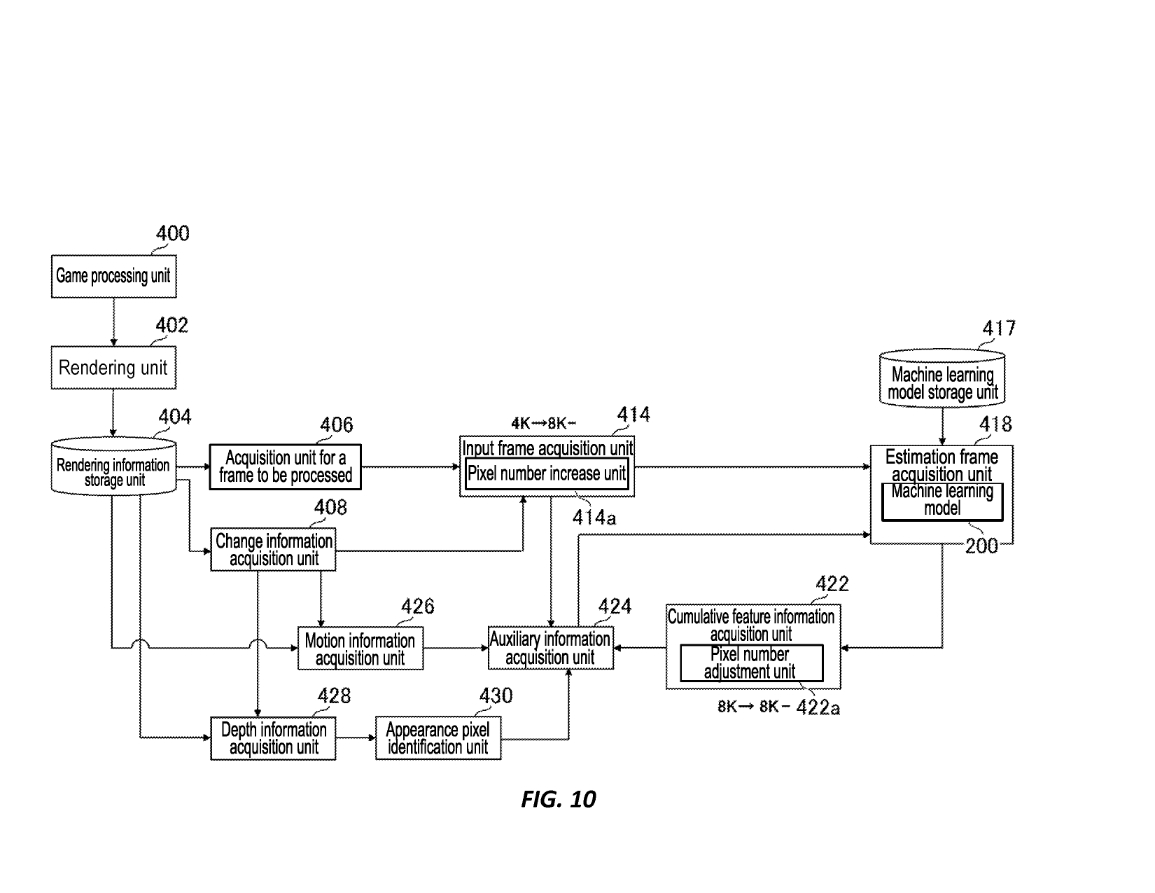

FIG. 9 is a drawing illustrating the overview of the image processing system 1 according to a variation of the present embodiment. FIG. 10 is a function block diagram illustrating an example of functions realized by the image processing system according to the variation of the present embodiment. For the same configurations as the present embodiment explained with reference to FIGS. 2 and 4, etc., the same reference numerals are used and the explanation thereof will be omitted.

In the above present embodiment, there is explained the example where the number of pixels of the frame 20 to be processed is increased in accordance with the two steps prior to the input to the machine learning model 400. Meanwhile, in the variation, there will be explained an example where the number of pixels of the frame 20 to be processed is increased in accordance with one step prior to the input to the machine learning model 200.

Specifically, the input frame acquisition unit 414 acquires the input frame 24 having the number of input pixels greater than the number of initial pixels of the frame 20 to be processed. The number of initial pixels is preferably, for example, 4K. In this case, the number of input pixels is preferably greater than 4K and less than 8K.

Then, the input frame 24 is inputted to the machine learning model 400 and the estimated frame 26 having the number of estimated pixels greater than the number of input pixels is to be outputted. The number of pixels of the auxiliary information 30 to be inputted to the machine learning model 200 is preferably the same number as the number of input pixels. Therefore, it is preferable that the image processing system 1 according to the variation does not have the number of pixels increase unit 432 shown in FIG. 4. The processing thereafter is identical to the one in the present embodiment explained with reference to FIG. 4, etc. The machine learning model 200 according to the variation preferably performs the learning beforehand so that the number of pixels of the frame to be outputted is greater than the number of pixels of the inputted frame. Specifically, the machine learning model 200 is preferably a model trained by a plurality of training data, which respectively includes a learning input frame having the number of input pixels (8K-) greater than 4K and smaller than 8K, and a learning estimated frame having the number of estimated pixels of 8K.

Also, in the variation, the estimation accuracy can be maintained and the processing load can be reduced as in the above present embodiment.

What is claimed is:

1. An image processing system comprising:
at least one processor; and
a memory device storing instructions that, when executed by the at least one processor, cause the system to:
acquire frames to be processed, each frame having a predetermined number of initial pixels;
generating input frames corresponding to the frames to be processed respectively, wherein each of the input frames has a number of input pixels greater than the predetermined number;
provide each of input frames to a machine learning model to acquire each of estimated frames having a number of estimated pixels, wherein the machine learning model comprises a cumulative feature information output layer having an n^{th} input frame, where n is a natural number equal to or greater than 2, and (n-1)^{th} auxiliary information based on (n-1)^{th} cumulative feature information indicating features of 1^{st} to (n-1)^{th} input frames, the cumulative feature information output layer outputting n^{th} cumulative feature information indicating features of the 1^{st} to n^{th} input frames;
adjust a number of pixels of the (n-1)^{th} cumulative feature information to be smaller than the number of estimated pixels; and
acquire the (n-1)^{th} auxiliary information, based on the (n-1)^{th} cumulative feature information having the number of pixels of the (n-1)^{th} cumulative feature information.

2. The image processing system according to claim 1,
wherein the instructions that, when executed by the at least one processor, further cause the system to:
generate intermediate frames which correspond to the frames to be processed respectively, each of the intermediate frames having a number of intermediate pixels that is greater than the number of initial pixels; and
generate the input frames which correspond to the intermediate frames, each of the input frame having a number of input pixels that is greater than the number of intermediate pixels.

3. The image processing system according to claim 2,
wherein the number of input pixels and the number of estimated pixels are equal.

4. The image processing system according to claim 1,
wherein the machine learning model is trained to output the estimated frame having the number of estimated pixels greater than a number of input pixels of the input frame.

5. An image processing method, comprising:
acquiring frames to be processed, each frame having a predetermined number of initial pixels;
generating input frames corresponding to the frames to be processed respectively, wherein each of the input frames has a number of input pixels greater than the predetermined number;
providing each of input frames to a machine learning model to acquire each of estimated frames having a number of estimated pixels, wherein the machine learning model comprises a cumulative feature information output layer having an n^{th} input frame, where n is a natural number equal to or greater than 2, and (n-1)^{th} auxiliary information based on (n-1)^{th} cumulative feature information indicating features of 1^{st} to (n-1)^{th} input frames, the cumulative feature information output layer outputting n^{th} cumulative feature information indicating the features of the 1^{st} to n^{th} input frames;
adjusting a number of pixels of the (n-1)^{th} cumulative feature information to be smaller than the number of estimated pixels; and
acquiring the (n-1)^{th} auxiliary information, based on the (n-1)^{th} cumulative feature information having the number of pixels of the (n-1)^{th} cumulative feature information.

6. The image processing method of claim 5, further comprising:
generating intermediate frames which correspond to the frames to be processed respectively, each of the intermediate frames having a number of intermediate pixels that is greater than the number of initial pixels; and
generating the input frames which correspond to the intermediate frames, each of the input frame having a number of input pixels that is greater than the number of intermediate pixels.

7. The image processing method of claim 6,
wherein the number of input pixels and the number of estimated pixels are equal.

8. The image processing method of claim 5,
wherein the machine learning model is trained to output the estimated frame having the number of estimated pixels greater than a number of input pixels of the input frame.

9. A non-transitory computer-readable medium storing computer-readable instructions that, when executed by a computer, cause the computer to perform operations comprising:
acquiring frames to be processed, each frame having a predetermined number of initial pixels;
generating input frames corresponding to the frames to be processed respectively, wherein each of the input frame has a number of input pixels greater than the predetermined number;
providing each of input frames to a machine learning model to acquire each of estimated frames having a number of estimated pixels, wherein the machine learning model comprises a cumulative feature information output layer having an n^{th} input frame, where n is a natural number equal to or grater than 2, and (n-1)^{th} auxiliary information based on (n-1)^{th} cumulative feature information indicating features of 1^{st} to (n-1)^{th} input frames, the cumulative feature information output layer outputting n^{th} cumulative feature information indicating the features of the 1^{st} to n^{th} input frames;
adjusting a number of pixels of the (n-1)^{th} cumulative feature information to be smaller than the number of estimated pixels; and
acquiring the (n-1)^{th} auxiliary information, based on the (n-1)^{th} cumulative feature information having the number of pixels of the (n-1)^{th} cumulative feature information.

10. The non-transitory computer-readable medium of claim 9, wherein the operations further comprise:
generating intermediate frames which correspond to the frames to be processed respectively, each of the intermediate frames having a number of intermediate pixels that is greater than the number of initial pixels; and
generating the input frames which correspond to the intermediate frames, each of the input frame having a number of input pixels that is greater than the number of intermediate pixels.

11. The non-transitory computer-readable medium of claim 10,
wherein the number of input pixels and the number of estimated pixels are equal.

12. The non-transitory computer-readable medium of claim 9,
wherein the machine learning model is trained to output the estimated frame having the number of estimated pixels greater than a number of input pixels of the input frame.
